(19) United States
(12) Patent Application Publication
(10) Pub. No.: US 2023/0067206 A1
(43) Pub. Date: Mar. 2, 2023

(54) ALUMINUM ALLOY FOR CASTING HIGH-STRENGTH AND HIGH ELECTRICALLY CONDUCTIVE COMPONENTS

(71) Applicant: GM Global Technology Operations LLC, Detroit, MI (US)

(72) Inventors: Qigui Wang, Rochester Hills, MI (US); Margarita P. Thompson, Livonia, MI (US)

(21) Appl. No.: 17/462,536

(22) Filed: Aug. 31, 2021

(51) Int. Cl. C22C 21/08; C22F 1/047

(52) U.S. Cl. CPC C22C 21/08; C22F 1/047

(57) ABSTRACT

An electrically conductive aluminum diecast alloy and an induction motor rotor made of the diecast aluminum alloy. The aluminum alloy includes commercially pure aluminum and a sufficient weight percent (wt%) of Copper (Cu), Magnesium (Mg), and Silicon (Si) to precipitate a 0.1 wt% to 5.0 wt% of a thermally stable Q-phase precipitate, AlwCuxMgySiz, after age hardening. Wherein w = about 14.3 at% to about 23.82 at% of Al; x = about 5.90 at% to about 9.52 at% of Cu; y = about 35.30 at% to about 42.85 at% of Mg; and z = about 28.57 at% to about 35.30 at% of Si. The induction motor rotor includes an aluminum squirrel cage rotor diecast onto a laminated electrical steel. The aluminum diecast squirrel cage rotor includes about 1.0 wt% of thermally stable Al₅Cu₂Mg₈Si₆ after age hardening.

### INTRODUCTION

The present disclosure relates generally to aluminum casting alloys, particularly to an aluminum alloy for casting high-strength and high electrically conductive components such as induction motor rotors.

Induction motors, also known as an asynchronous motor, are commonly used alternating current (AC) electric motors. An induction motor includes primarily a stator and a rotor assembly rotatably disposed within the stator. The stator is typically made up of stampings, which are slotted to receive windings. When the windings are supplied with a 3-phase current, the stator produces a revolving magnetic flux that induces an electrical-magnetic-flux (EMF) in the rotor assembly by mutual induction. The EMF of the rotor assembly seeks to align with the EMF of the stator, thereby causing the rotor assembly to rotate.

The majority of rotor assemblies in induction motors include a squirrel-cage rotor cast onto a laminated core formed of a stack of electrical steel disks. Cast squirrel-cage rotors are of relatively simple and rugged design. A typical cast squirrel-cage rotor includes two opposite end rings and a plurality of electrically conductive bars connecting the end rings. The conducting bars are usually not parallel to the axis of rotation of the rotor shaft, but slightly skewed for increased motor performance.

Often squirrel-cage rotors assemblies are manufactured by using high-pressure die-casting to produce the squirrel-cage rotor where the conducting bars are formed into slots defined in the laminated electrical steel core. In the manufacture of the rotor assembly, the laminated core is placed in a casting die. The casting die in conjunction with the electric steel core define a ring-shaped space at the top and bottom for simultaneous casting of the end rings, and conductive bar spaces connecting the top and bottom end ring-shaped spaces. Molten aluminum is injected into the casting die filling the top ring-shaped space, conductive bar spaces, bottom ring-shaped space, and encapsulating a portion of the laminated electrical steel core, thereby binding the entire rotor assembly together.

The squirrel-cage rotors are typically cast of commercially pure aluminum, which is 99.7% aluminum, due to its desired high electrically conductive properties. The higher the electrical conductivity results in the greater efficiency of the motor under normal load. Commercially pure aluminum is difficult to cast, partially due to the flowability of the molten aluminum into the complex shaped die, which may result in porosity in the cast rotor, effectively limiting the cross-section through which the induced electrical current flows.

Thus, while the current casting of aluminum rotors using commercially pure aluminum alloy achieve their intended purpose, there is a continual need for improved aluminum casting alloys that have superior casting properties and higher strength than commercially pure aluminum particularly at both ambient room temperature and elevated temperatures, while maintaining desired electrical conductive properties comparable to commercially pure aluminum.

### SUMMARY

According to several aspects, an aluminum alloy for diecasting an electrically conductive work piece is disclosed. The aluminum alloy comprises aluminum (Al), and a sufficient weight percent (wt%) of Copper (Cu), a sufficient wt% of Magnesium (Mg), and a sufficient wt% of Silicon (Si) to precipitate a 0.1 wt% to 5.0 wt% of at least one thermally stable Q-phase precipitate after age hardening. At least one thermally stable Q-phase precipitate is Al_{w}CuₓMg_{y}Si_{z}.

In an additional aspect of the present disclosure, w = about 14.3 at% to about 23.82 at% of AI; x = about 5.90 at% to about 9.52 at% of Cu; y = about 35.30 at% to about 42.85 at% of Mg; and z = about 28.57 at% to about 35.30 at% of Si.

In another aspect of the present disclosure, w = about 23.82 at% of AI; x = about 9.52 at% of Cu; y = about 38.09 at% of Mg; and z = about 28.57 at% of Si.

In another aspect of the present disclosure, the aluminum alloy includes about 0.027 wt% to about 1.734 wt% Si; about 0.030 wt% to about 1.754 wt% Mg; about 0.013 wt% to about 1.019 wt% Cu; and remaining wt% of Al.

In another aspect of the present disclosure, the aluminum alloy includes about 0.270 wt% to about 1.041 wt% Si; about 0.300 wt% to about 1.053 wt% Mg; about 0.131 wt% to about 0.611 wt% Cu; and remaining wt% of Al.

In another aspect of the present disclosure, the aluminum alloy includes about 0.270 wt% to about 0.347 wt% Si; about 0.300 wt% to about 0.351 wt% Mg; about 0.131 wt% to about 0.204 wt% Cu; and remaining wt% of Al.

In another aspect of the present disclosure, the Q-phase precipitate is Al₅Cu₂Mg₈Si₆

In another aspect of the present disclosure, the alloy further includes greater than 0 wt% to 0.2 wt% Iron (Fe); greater than 0 wt% to 0.5 wt% Manganese (Mn); greater than 0 wt% to 0.05 wt% Zinc (Zn); greater than 0 wt% to 0.25 wt% of a sum of Chromium (Cr), Nickel (Ni), Titanium (Ti), and Vanadium (V).

In another aspect of the present disclosure, the alloy further includes 0.13 wt% to 0.21 wt% Cu; 0.30 wt% to 0.35 wt% Mg; 0.27 wt% to 0.35 wt% Si; and remainder wt% Al to precipitate about 1.0 wt% of the at least one thermally stable Q-phase precipitate consisting essentially of Al₅Cu₂MgsSi₆.

According to several aspects, a diecast electrically conductive cast aluminum work piece is disclosed. The work piece includes Aluminum (Al) and 0.1 wt% to 5.0 wt% of a thermally stable Q-phase precipitate Al_{w}CuₓMg_{y}Si_{z}. Wherein: w = about 14.3 at% to about 23.82 at% of Al; x = about 5.9 at% to about 9.52 at% of Cu; y = about 35.3 at% to about 42.85 at% of Mg; and z = about 28.57 at% to about 35.3 at% of Si.

In another aspect of the present disclosure, the thermally stable Q-phase precipitate Al_{w}CuₓMg_{y}Si_{z} consist essentially of: w = about 23.82 at% of Al; x = about 9.52 at% of Cu; y = about 38.09 at% of Mg; and z = about 28.57% of Si.

In another aspect of the present disclosure, the thermally stable Q-phase precipitate Al_{w}CuₓMg_{y}Si_{z} is about 1.0 wt%.

In another aspect of the present disclosure, the thermally stable Q-phase precipitate Al_{w}CuₓMg_{y}Si_{z} includes one or more of a precipitate selected from a group consisting of Al₅Cu₂Mg₈Si₆, Al₄Cu₂Mg₈Si₇, Al₄Cu₁Mg₆Si₆, and Al₃Cu₂Mg₉Si₇.

In another aspect of the present disclosure, diecast electrically conductive cast aluminum work piece is a squirrel cage of an induction motor rotor assembly.

According to several aspects, an induction motor rotor is disclosed. The rotor includes a laminated electrical steel and a squirrel cage rotor diecast onto the laminated electrical steel. The squirrel cage rotor includes an age hardened aluminum alloy including about 0.1 weight percent (wt%) to about 5.0 wt% percent of a thermally stable Q-phase precipitate and a remaining wt% of commercially pure Aluminum (Al).

In another aspect of the present disclosure, the Q-phase precipitate comprises at least one Al_{w}CuₓMg_{y}Si_{z} precipitate. Where w = about 14.3 atomic percent (at%) to about 23.82 at% of Al; x = about 5.9 at% to about 9.52 at% of Copper (Cu); y = about 35.3 at% to about 42.85 at% of Magnesium (Mg); and z = about 28.57 at% to about 35.3 at% of Silicon (Si).

In another aspect of the present disclosure, the age hardened aluminum alloy comprising about 1.0 wt% of the Q-phase precipitate.

In another aspect of the present disclosure, wherein the Q-phase precipitate comprises Al₅Cu₂Mg₈Si₆.

In another aspect of the present disclosure, wherein the age hardened aluminum alloy comprises: about 0.270 wt% to about 0.347 wt% Si; about 0.300 wt% to about 0.351 wt% Mg; and about 0.131 wt% to about 0.204 wt% Cu.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an exploded perspective view of a squirrel-cage rotor assembly for an induction motor, according to an exemplary embodiment;

FIG. 2 is a graph showing the ultimate tensile strength and yield strength of an aluminum alloy having Mg₂Si precipitates and of an aluminum alloy having Q-phase precipitates over a temperature range;

FIG. 3 is a graph showing a relationship between fluidity and weight percentage of selected elemental metals in an aluminum alloy;

FIG. 4 is a graph showing a relationship between castibility and weight percentage of selected elemental metals in an aluminum alloy;

FIG. 5 is a graph showing a relationship between hot tear sensitivity and weight percentage of selected elemental metals in an aluminum alloy; and

FIG. 6 is a block flow diagram of a method of making an electrically conductive induction motor rotor.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

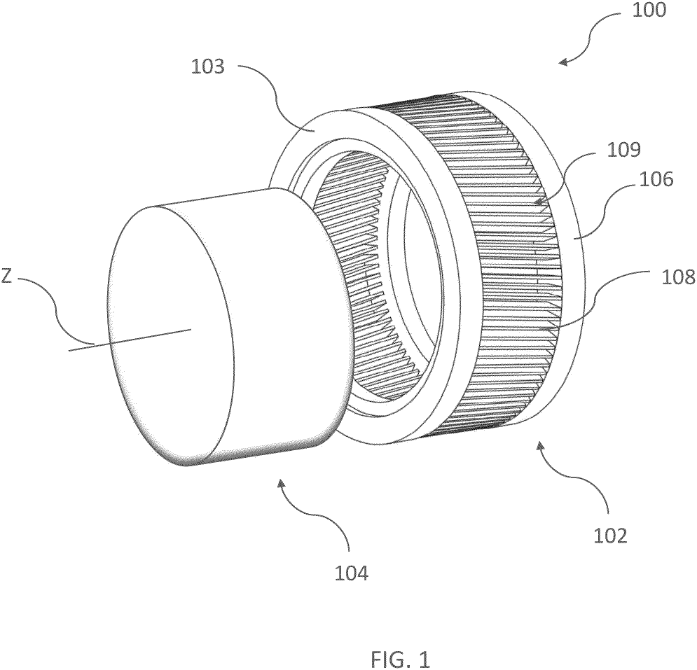

Shown in FIG. 1 is an exploded perspective view of a rotor assembly 100 for an induction motor. The rotor assembly 100 includes a squirrel cage 102, a simplified laminated core 104 disposed within the squirrel cage 102, and a rotor shaft (not shown) extending along an axis Z of rotation of the rotor assembly 100. The squirrel cage 102 includes a first ring end 105, a second ring 106 end spaced apart from the first ring end 105, and a plurality of equally spaced parallel bars 108 connecting the first ring end 105 to the second ring end 106. The squirrel cage 102 is a single piece component cast from an improved aluminum alloy that exhibits improved strength while retaining high electrical conductivity as compared to a squirrel cage cast from commercially pure aluminum alone.

The improved aluminum alloy has good castability, high electrical conductivity, and good mechanical properties particularly at both ambient room temperature and elevated temperatures. The improved aluminum alloy is composed of commercially pure aluminum (Al) together with a sufficient weight percent (wt%) of Copper (Cu), a sufficient wt% of Magnesium (Mg), and a sufficient wt% of Silicon (Si) to precipitate a 0.1 wt% to 5.0 wt% of at least one thermally stable Q-phase precipitate after age hardening. An exemplary Q-phase precipitate is expressed by the formula Al_{w}CuₓMg_{y}Si_{z}, where:
w = atomic percent (at%) of Al;
x = at% of Copper (Cu);
y = at% of Magnesium (Mg); and
z = at% of Silicon (Si).

Table 1 below presents four (4) exemplary embodiments of thermally stable Q-phase precipitates having the formula Al_{w}CuₓMg_{y}Si_{z} and corresponding at% of Al, Cu, Mg, Si in the Q-phase precipitates after the improved Al alloy has been age hardened. The maximum (Max) at% and the minimum (Min) at% of each of Al, Cu, Mg, Si for the 4 exemplary embodiments of the thermally stable Q-phase precipitates are also shown in Table 1.

Table 1

| Q-Phase Embodiment | Q-Phase | at% Al | at% Cu | at% Mg | at% Si |
|---|---|---|---|---|---|
| Embodiment 1 | Al₅Cu₂Mg₈Si₆ | 23.82 | 9.52 | 38.09 | 28.57 |
| Embodiment 2 | Al₄Cu₂Mg₈Si₇ | 19.06 | 9.52 | 38.09 | 33.33 |
| Embodiment 3 | Al₄Cu₁Mg₆Si₆ | 23.50 | 5.90 | 35.30 | 35.30 |
| Embodiment 4 | Al₃Cu₂Mg₉Si₇ | 14.30 | 9.52 | 42.85 | 33.33 |
| Embodiments 1-4 | Max | 23.82 | 9.52 | 42.85 | 35.30 |
| Embodiments 1-4 | Min | 14.30 | 5.90 | 35.30 | 28.57 |

Table 2 below presents the 4 exemplary embodiments of the thermally stable Q-phase precipitates of Table 1 and corresponding weight percent (wt%) of Al, Cu, Mg, Si in each of the embodiments of the Q-phase precipitates. The maximum (Max) wt% and the minimum (Min) wt% of each of Al, Cu, Mg, Si are also shown in Table 2.

Table 2

Q-Phase Embodiments

| | 1 | 2 | 3 | 4 | | |
|---|---|---|---|---|---|---|
| Element | wt% | wt% | wt% | wt% | Max wt% | Min wt% |
| Al | 21.60 | 17.25 | 22.18 | 13.00 | 13.00 | 22.18 |
| Si | 26.96 | 31.40 | 34.68 | 31.54 | 26.96 | 34.68 |
| Mg | 31.11 | 31.05 | 30.02 | 35.09 | 30.02 | 35.09 |
| Cu | 20.33 | 20.29 | 13.12 | 20.30 | 13.12 | 20.38 |

Based on the wt% of Al, Cu, Mg, and Si of the Q-phase precipitates shown in Table 2, the wt% of Cu, Mg, and Si required to be added to a commercially pure Al can be calculated to provide for the improved aluminum alloy to precipitate a 0.1 wt% to 5.0 wt% of at least one thermally stable Q-phase precipitate after age hardening, wherein the at least Q-phase precipitate is Al_{w}CuₓMg_{y}Si_{z}.

Table 3 shows a minimal and maximum wt% of Cu, Mg, and Si required in an aluminum alloy to precipitate between 0.1% to 5.0 wt% Q-phase having the formula Al_{w}CuₓMg_{y}Si_{z}.

Table 3

Electrically conductive Cast Aluminum Alloy

| | 0.1% Q-phase | | 1.0% Q-Phase | | 3.0% Q-Phase | | 5.0% Q-Phase | |
|---|---|---|---|---|---|---|---|---|
| Element | Min | Max | Min | Max | Min | Max | Min | Max |
| Al | 0.013 | 0.022 | 0.130 | 0.222 | 0.390 | 0.665 | 0.650 | 1.109 |
| Si | 0.027 | 0.035 | 0.270 | 0.347 | 0.809 | 1.041 | 1.348 | 1.734 |
| Mg | 0.030 | 0.035 | 0.300 | 0.351 | 0.900 | 1.053 | 1.501 | 1.754 |
| Cu | 0.013 | 0.020 | 0.131 | 0.204 | 0.393 | 0.611 | 0.656 | 1.019 |

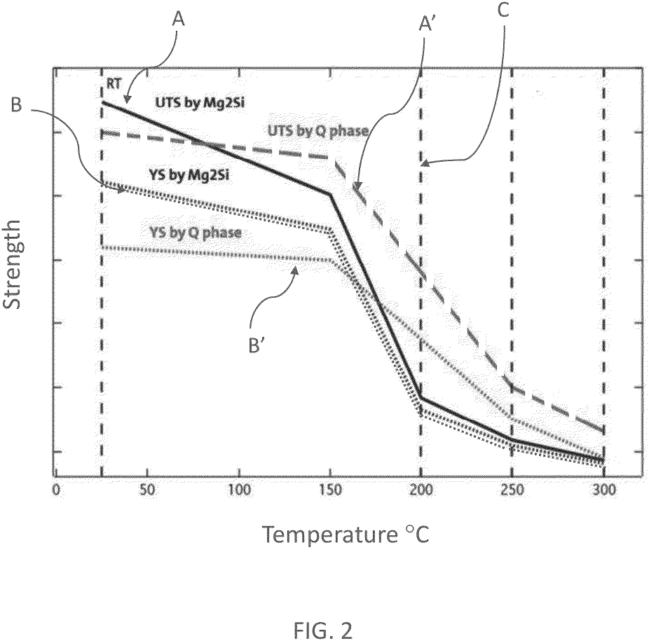

FIG. 2 shows a graph of the ultimate tensile strength (UTS) and yield strength (YS) of an aluminum casting alloy having Mg₂Si precipitates versus the UTS and YS of the improved aluminum casting alloy having Q-phase Al_{w}CuₓMg_{y}Si_{z} precipitates. The ultimate tensile strength and yield strength are represented on the y-axis and temperature is represented on the x-axis. The UTS curve of the Al alloy having Mg₂Si precipitates is indicated by the reference character A and shown as a solid heavy-line. The UTS curve of the Al alloy having Q-phase Al_{w}CuₓMg_{y}Si_{z} precipitates is designated by reference character A′ and shown as a dashed heavy-line. The YS curve of the Al alloy having Mg₂Si precipitates is designated by the reference character B and shown as a double dotted light-line. The YS curve of the Al alloy having Q-phase Al_{w}CuₓMg_{y}Si_{z} precipitates is designated by reference character B′ and shown as a single dotted light-line.

At lower temperatures, shown left of the vertical dash line C, the UTS and YS of the age hardened cast Al alloy having Q-phase Al_{w}CuₓMg_{y}Si_{z} precipitates is slightly lower than the UTS and YS of the cast Al alloy having Mg₂Si precipitates, but within acceptable range for a casted squirrel cage rotor. However, at elevated temperatures, shown right of the vertical dash line C, the UTS and YS of the cast Al alloy having Q-phase Al_{w}CuₓMg_{y}Si_{z} precipitates outperforms the UTS and YS of the cast Al alloy having Mg₂Si precipitates. The lower temperatures at which the Al alloy having Q-phase Al_{w}CuₓMg_{y}Si_{z} precipitates has lower UTS and YS are not as important to the application of induction motors because the squirrel cage rotor heats up during normal operating conditions. Having higher UTS and YS at the higher operating temperatures is more beneficial to the applications of induction motors.

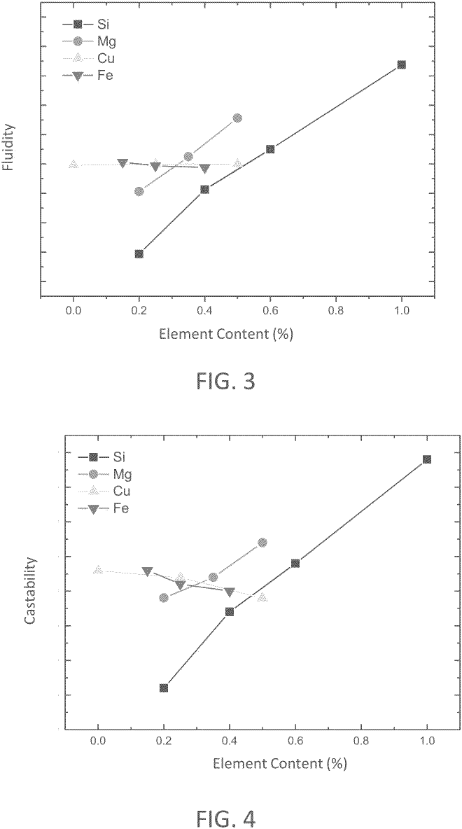

Adding Si, Mg, Cu contents to a commercially pure Al alloy increases strengths but may reduces ductility. Adding Fe may also reduce ductility. However, referring to FIG. 3 and FIG. 4, the increase of Si and Mg appears to increase fluidity and castability, while the addition of Cu and Fe seems to have little adverse effect on castability. The improved aluminum alloy may include Si, Mg, Cu and greater than 0 wt% to 0.2 wt% Iron (Fe), greater than 0 wt% to 0.5 wt% Manganese (Mn), and greater than 0 wt% to 0.05 wt% Zinc (Zn). The improved aluminum alloy may further include greater than 0 wt% to 0.25 wt% of a sum of Chromium (Cr), Nickel (Ni), Titanium (Ti), and Vanadium (V).

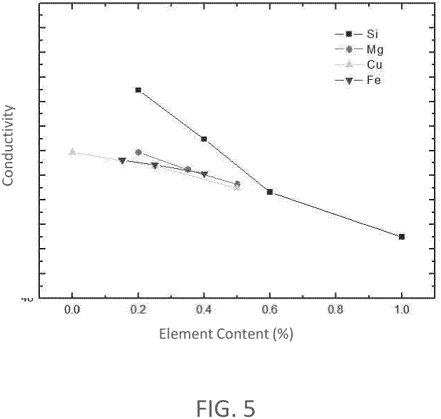

FIG. 5 shows a relationship between conductivity and weight percentage of selected elemental metals. FIG. 5 shows that increasing the wt% of Si, Mg, Cu, and Fe decreases somewhat the electrical conductivity of the improved alloy as compared to a commercially pure aluminum alloy. However, the decrease in electrical conductivity is less substantial than other commercially available Al alloys while providing superior strength and castability over commercially pure Al.

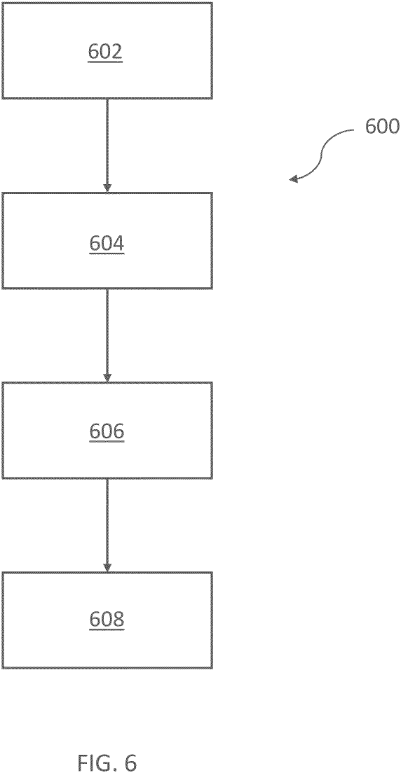

FIG. 6 show a block diagram for a method 600 of making the improved alloy and using the improved alloy to make an electrically conductive component such as a rotor assembly of an electric motor. The method starts in block 602, where master alloys containing Si, Mg, and Cu are melted together with commercially pure Al in accordance with the wt% shown in Table 3 to precipitate a corresponding 0.1 wt%, 1.0 wt%, 3.0 wt%, or 5.0 wt% of at least one thermally stable Q-phase precipitate after age hardening. For example, to make an improved alloy to precipitate a 1.0% Q-phase precipitate having the formula Al_{w}CuₓMg_{y}Si_{z}, a minimal of 0.27 wt% to 0.347 wt of Si, a minimal of 0.300 wt% to 0.351 wt of Mg, and a minimal of 0.131 wt% to 0.204 wt% of Cu, and a remaining wt% of commercially pure Al is required to be in the molten alloy. As disclosed above, the improved aluminum alloy may also include Fe, Mn, Zn, Cr, Ni, Ti, and V in small to trace amounts.

Moving to block 604, the molten improved aluminum alloy undergoes the processes of degassing to remove hydrogen, fluxing to remove aluminum oxides, and adding grain refinement such as TiB, Ce or La.

Moving to block 606, the molten improved aluminum alloy is poured or injected into a diecast mold that defines an die cast electrically conductive component. In one embodiment, the electrically conductive component is squirrel-cage rotor assembly 100 of FIG. 1 that includes a squirrel-cage 102 injection die-cast onto a laminated electrical steel core 104. In this particular embodiment, the diecast mold defines a hollow volume of space to receive the laminated electric steel core 104 and a hollow form factor in a shape of a squirrel cage rotor 106 surrounding the laminated electrical steel stack 104. The hollow form factor of the squirrel cage rotor includes two spaced apart end rings 103, 106 and a plurality of bars 108 interconnecting the two end rings 103, 106. The laminated electrical steel core 104 may include a shape that extends into the slots 109 defined between pairs of adjacent bars 108.

Moving to block 608, the diecast electrically conductive component is heat treated at 450° C. to 550° C. for 0.5 to 12 hours isothermally, multi-step isothermally, or non-isothermally, preferably isothermally at 530° C. for 2 hours. The diecast electrically conductive component is then quenched in a liquid or gas medium at 25° C. to 100° C. For example, the hot diecast electrically conductive component may be quenched in 90° C. water. After quenching, the work piece is aged at 100° C. to 250° C. for 1 to 10 hours isothermally, multi-step isothermally, or non-isothermally to effectuate the precipitation of a desired wt% of Q-phase and a given embodiment or embodiments of Q-phases. For example, the work piece may be aged isothermally at 200° C. for 4 hours.

The above disclosure provides an improved high strength and improved castability aluminum alloy containing up to 1.0 wt% Si, up to 0.5 wt% Mg, up to 0.5 wt% Cu, up to 0.2 wt% Fe, up to 0.5 wt% Mn, up to 0.05 wt% Zn, and up to 0.025 wt% of the sum of Cr, Ni, Ti, and V. The improved high strength and castability conductivity aluminum alloy is suitable for die-casting aluminum induction rotors for electric motors due to its comparable electrical conductive properties as that of commercially pure aluminum. A preferable combination of alloying elements Si, Mg, and Cu in the alloys is to form substantially 100% thermal stable Q precipitates, preferably AlsCu₂Mg₈Si₆, after age hardening. The improved Al alloy is absent of β(AlFeSi), therefore improving material ductility. The improved Al Alloy is suitable for high pressure die casting and metal mold casting with high die soldering resistance. The improved Al alloy also has better mechanical properties particularly at elevated temperatures as compared to commercially pure Al while maintaining comparable electrical conductivity as commercially pure Al.

Numerical data have been presented herein in a range format. “The term “about” as used herein is known by those skilled in the art. Alternatively, the term “about” includes +/- 0.05% by weight”. It is to be understood that this range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. While examples have been described in detail, those familiar with the art to which this disclosure relates will recognize various alternative designs and examples for practicing the disclosed method within the scope of the appended claims.

The description of the present disclosure is merely exemplary in nature and variations that do not depart from the general sense of the present disclosure are intended to be within the scope of the present disclosure. Such variations are not to be regarded as a departure from the spirit and scope of the present disclosure.

What is claimed is:

1. An aluminum alloy for diecasting an electrically conductive work piece, comprising:
aluminum (Al); and
a sufficient weight percent (wt%) of Copper (Cu), a sufficient wt% of Magnesium (Mg), and a sufficient wt% of Silicon (Si) to precipitate a 0.1 wt% to 5.0 wt% of at least one thermally stable Q-phase precipitate after age hardening, wherein the at least one thermally stable Q-phase precipitate is Al_{w}CuₓMg_{y}Si_{z}:
w = atomic percent (at%) of AI;
x = at% of Copper (Cu);
y = at% of Magnesium (Mg); and
z = at% of Silicon (Si).

2. The aluminum alloy of claim 1, wherein:
w = about 14.3 at% to about 23.82 at% of AI;
x = about 5.90 at% to about 9.52 at% of Cu;
y = about 35.30 at% to about 42.85 at% of Mg; and
z = about 28.57 at% to about 35.30 at% of Si.

3. The aluminum alloy of claim 1, comprising about 1.0 wt% of the Q-phase precipitate Al_{w}CuₓMg_{y}Si_{z}, wherein:
w = about 23.82 at% of AI;
x = about 9.52 at% of Cu;
y = about 38.09 at% of Mg; and
z = about 28.57 at% of Si.

4. The aluminum alloy of claim 1, comprising:
about 0.027 wt% to about 1.734 wt% Si;
about 0.030 wt% to about 1.754 wt% Mg;
about 0.013 wt% to about 1.019 wt% Cu; and
remaining wt% of Al.

5. The aluminum alloy of claim 1, comprising:
about 0.270 wt% to about 1.041 wt% Si;
about 0.300 wt% to about 1.053 wt% Mg;
about 0.131 wt% to about 0.611 wt% Cu; and
remaining wt% of Al.

6. The aluminum alloy of claim 1, comprising:
about 0.270 wt% to about 0.347 wt% Si;
about 0.300 wt% to about 0.351 wt% Mg;
about 0.131 wt% to about 0.204 wt% Cu; and
remaining wt% of Al.

7. The aluminum alloy of claim 1, wherein the Q-phase precipitate is Al₅Cu₂MgsSi₆.

8. The aluminum alloy of claim 7, further comprising:
greater than 0 wt% to 0.2 wt% Iron (Fe);
greater than 0 wt% to 0.5 wt% Manganese (Mn); and
greater than 0 wt% to 0.05 wt% Zinc (Zn).

9. The aluminum alloy of claim 8, further comprising greater than 0 wt% to 0.25 wt% of a sum of Chromium (Cr), Nickel (Ni), Titanium (Ti), and Vanadium (V).

10. The aluminum alloy of claim 1, comprising:
0.13 wt% to 0.21 wt% Cu;
0.30 wt% to 0.35 wt% Mg;
0.27 wt% to 0.35 wt% Si; and
remainder wt% Al to precipitate about 1.0 wt% of the at least one thermally stable Q-phase precipitate consisting essentially of Al₅Cu₂Mg₈Si₆.

11. A diecast electrically conductive cast aluminum work piece, consisting essentially of:
Aluminum (Al);
0.1 wt% to 5.0 wt% of a thermally stable Q-phase precipitate Al_{w}CuₓMg_{y}Si_{z}, wherein:
w = about 14.3 at% to about 23.82 at% of AI;
x = about 5.9 at% to about 9.52 at% of Cu;
y = about 35.3 at% to about 42.85 at% of Mg; and
z = about 28.57 at% to about 35.3 at% of Si.

12. The diecast electrically conductive cast aluminum work piece of claim 11, wherein the thermally stable Q-phase precipitate Al_{w}CuₓMg_{y}Si_{z} consist essentially of:
w = about 23.82 at% of AI;
x = about 9.52 at% of Cu;
y = about 38.09 at% of Mg; and
z = about 28.57% of Si.

13. The diecast electrically conductive cast aluminum work piece of claim 11, wherein the thermally stable Q-phase precipitate Al_{w}CuₓMg_{y}Si_{z} is about 1.0 wt. %.

14. The diecast electrically conductive cast aluminum work piece of claim 13, wherein the thermally stable Q-phase precipitate Al_{w}CuₓMg_{y}Si_{z} includes one or more of a precipitate selected from a group consisting of Al₅Cu₂Mg₈Si₆, Al₄Cu₂Mg₈Si₇, Al₄Cu₁Mg₆Si₆, and Al₃Cu₂Mg₉Si₇.

15. The diecast electrically conductive cast aluminum work piece of claim 14, wherein diecast electrically conductive cast aluminum work piece is a squirrel cage of an induction motor rotor assembly.

16. An induction motor rotor, comprising:
a laminated electrical steel;
a squirrel cage rotor cast onto the laminated electrical steel, wherein the squirrel cage rotor includes an age hardened aluminum alloy comprising:
about 0.1 weight percent (wt%) to about 5.0 wt% percent of a thermally stable Q-phase precipitate; and
a remaining wt% of commerciallly pure Aluminum (Al).

17. The induction motor rotor of claim 16, wherein the Q-phase precipitate comprises at least one Al_{w}CuₓMg_{y}Si_{z} precipitate, where:
w = about 14.3 atomic percent (at%) to about 23.82 at% of AI;
x = about 5.9 at% to about 9.52 at% of Copper (Cu);
y = about 35.3 at% to about 42.85 at% of Magnesium (Mg); and
z = about 28.57 at% to about 35.3 at% of Silicon (Si).

18. The induction motor rotor of claim 17, wherein the age hardened aluminum alloy comprising about 1.0 wt% of the Q-phase precipitate.

19. The induction motor rotor of claim 18, wherein Q-phase precipitate comprises Al₅Cu₂Mg₈Si₆.

20. The induction motor rotor of claim 16, wherein the age hardened aluminum alloy comprises:
about 0.270 wt% to about 0.347 wt% Si;
about 0.300 wt% to about 0.351 wt% Mg; and
about 0.131 wt% to about 0.204 wt% Cu.
